(19) United States
(12) Patent Application Publication
(10) Pub. No.: US 2006/0115350 A1
(43) Pub. Date: Jun. 1, 2006

(54) Device for automatically installing and reoving twistlocks

(76) Inventor: Otto Weis, Oberpleichfeld (DE)

Correspondence Address: WILLIAM COLLARD;COLLARD & ROE, P.C., 1077 NORTHERN BOULEVARD, ROSLYN, NY, 11576, US

(21) Appl. No.: 10/542,236

(22) PCT Filed: Jan. 12, 2004
(86) PCT No.: PCT/DE04/00019

§ 371 Date: Jul. 15, 2005

(30) Foreign Application Priority Data
Jan. 15, 2003 (US) 103011978

(51) Int. Cl. B65G 67/60

(52) U.S. Cl. 414/139.4

(57) ABSTRACT

The invention relates to a device for automatically mounting or removing twistlocks in the corners of containers in order to interconnect containers in such a way as to increase stability during transport. Said device consists of container part, (17, 18, 19, 20) comprising handling openings (26) into which die twistlocks (10) project once the container (6) has been set down, the distance between said openings being adjustable, twistlock grippers (34) which are arranged inside the container (17, 18, 19, 10) and are used to remove or to mount the twistlock (20), and storage possibilities for twistlocks (10).

The invention relates to a device for automatically installing or removing twistlocks in the corners of containers, in accordance with the preamble of the first claim.

The invention is suitable for installing and removing twistlocks in the corners of containers, which are connected with one another during transport, for example on ships, for stable storage, whereby the installation and removal is supposed to take place automatically.

All containers that are transported on the deck of container ships are connected with one another and with the hatch cover by means of twistlocks. This is done in the following four twistlock handling procedures: Installation of the twistlocks into each container corner on the pier, locking of the twistlocks on the ship, release of the twistlocks on the ship, and removal of the twistlocks from the container corners on the pier.

Except for the semi-automatic locking on the ship, all of the activities are performed manually. The manual activity of installation and removal of the twistlocks on the pier are personnel-intensive and time-consuming, require much strength, and involve the risk of accidents. Therefore there is a need, worldwide, for automating these procedures (Port of Rotterdam, Fall 2002, p. 12, 13).

For handling and lashing on container ships, the containers have corner fittings on the top and bottom, into which spreaders or other lifting means engage on the top for transport, and into which releasable connection means, such as twistlocks, are installed on the top and bottom, as seaworthy transport securing devices on container ships.

These twistlocks are absolutely necessary as connection means for the containers on the container ship deck. In order to simplify the procedures, more and more semi-automatic twistlocks are being used when loading the containers onto the ship. With these semi-automatic twistlocks, the method of procedure is as follows:

The container standing ready on the pier to be loaded onto the deck of a container ship is picked up with the container bridge spreaders and lifted to a height of approximately 1.5 m. Semi-automatic twistlocks are installed into the lower container corner fittings, by hand, and secured by means of pre-determined locking movements, depending on the type of twistlock. After the transport trip to the container ship with the container bridge trolley, the hammer-like twistlock locking bolt is moved into the corner fittings, when the container is set down onto the hatch cover or another container that has already been set down, and locking is triggered by means of the weight of the container, as well as by a spring integrated into the twistlock.

Using this method, all the containers on the deck are vertically connected with one another.

Diagonally disposed tie rods are installed to counter the horizontal forces that occur during rough seas.

During unloading of the containers from the container ship, there are no automatic mechanisms for removing the twistlock.

All of the work must be performed manually, as described below.

After removal of the diagonal tie rods, the twistlocks are released from the lower container or the hatch cover by means of a manual unlocking procedure. The container is picked up with the container spreader, lifted, and transported to the pier, with the twistlocks projecting on the underside of the containers. There, at a height of approximately 1.5 m, the twistlocks are removed by hand and placed into grid box pallets that belong to the ship.

The twistlocks are the property of the ship. Only one type of twistlocks is used per ship, in each instance.

In the European patent EP 0 699 164 B1, a method is described, in which intermediate coupling units are installed on and removed from containers, using mechanical means (nothing automatic), and stored in crates. These crates are configured to be adjustable for different containers, 20 ft and 40 ft, and must first be moved in case of a change in container size. However, this method does not represent an automatic method.

It is therefore the task of the invention to develop a possibility with which the installation and removal of twistlocks that connect the containers while they are stored on a ship can take place automatically.

This task is accomplished by means of a device that has the characterizing features of the first claim.

Dependent claims reproduce advantageous embodiments of the invention.

The solution according to the invention provides for a device for automatic installation and removal of twistlocks in the corners of containers, with which twistlocks can be installed in and removed from containers of different sizes, and which is adjustable to containers of different sizes. This device, which corresponds, in the collapsed state, with the corner fittings having the dimensions of a 40 ft container, can easily be transported along on the ship that transports the containers with the twistlocks. Before unloading of the ship takes place, the device is unloaded, and is adjusted to the container size to be unloaded, in such a manner that the containers can be set down onto the device, whereby the device performs the removal and insertion of the twistlocks.

In this connection, power is provided by way of an electrical cable that is connected to the container bridge, for example. Alternatively, a power supply by way of an integrated battery is possible, whereby the battery could be recharged on board, during the ship's trip. When using a battery, it is possible that the start-up, e.g. the extension and the data transmission, can be performed from the ship, by way of radio.

In an advantageous embodiment, the solution according to the invention consists of four container parts disposed next to one another, which form the so-called twistlock container, into the surface of which handling openings are recessed, into which the twistlocks of the unloaded containers project. Instead of a container made up of four container parts, four containers disposed next to one another are also possible. However, it is also possible to use a single container, but this would then have a size that exceeds the outside dimensions of all the containers to be processed. As a rule, two longitudinally shaped handling openings are disposed in the surface. With this, the most common container sizes of 20 ft and 40 ft can be processed, so that the distance of the container parts relative to one another no longer has to be changed. If container sizes other than those mentioned are supposed to be processed, the distance between the container parts in which the twistlocks are removable can be changed, relative to one another. There are various possibilities for this. For one thing, it is possible to dispose an automatically adjustable crosswise and longitudinal guide for the four container parts, with which the distances of the container parts relative to one another can be changed. For this, it is advantageous to dispose casters under each of the four container parts, which are attached to the base plate. In this embodiment, it is advantageous to dispose a cap part in the center, between all four container parts, which fixes the four container parts in place relative to their substratum. In simplest manner, this cap part can be a mandrel with which the longitudinal and crosswise guides are fixed in place, so that all four container parts can be moved relative to this mandrel, in targeted manner.

Another embodiment of the invention provides that only one container or container part is provided with a cap part, which connects the one container or the container part with the substratum in suitable manner, i.e. fixes it in place on this substratum.

The other three container parts are provided with longitudinal rollers, crosswise rollers, and casters, in such a manner that they can be moved up to the first container part, after which fixation by means of crosswise and longitudinal guides takes place. The crosswise and longitudinal guides can be configured to be resistant to bending, in order to guarantee the functionality of the twistlock container in every position and if the floor is uneven. Furthermore, it is possible to extend the container parts beyond greatest container dimensions, so that there is good accessibility, e.g. in case of maintenance of the twistlock container.

It is furthermore advantageous to dispose seals between the container parts, so that rainwater, dirt, or other things cannot penetrate between the container parts. For example, rubber or plastic linings are possible as seals.

Function heads for removal and installation of the twistlocks are disposed within each container part. Depending on the number of handling openings in each container part, one or two function heads with twistlock grippers can be disposed in each container part. The function heads with the integrated twistlock grippers, the unlocking levers, the sensors, as well as the twistlock accommodation parts on the transport chain correspond to the twistlock type being used, in each instance, and are interchangeable. The twistlock grippers grip the twistlocks and perform rotational and pulling movements to remove them, in connection with the unlocking lever in the function head. If necessary, a shaking movement can also be connected with this, which ensures that the gripper shakes the twistlock that projects into the handling opening loose from the opening of the corner fitting, so that it is easy to remove. In each device that consists of four container parts, at least four of the eight twistlock grippers work independently of one another, in the case of two handling openings, four, in each instance, work alternately. As soon as the twistlock gripper has removed the twistlock, it passes the latter on to a twistlock accommodation part on a transport chain, in which the twistlock can be stored. As soon as a twistlock has been handed over to the twistlock accommodation part, the twistlock gripper moves back in the direction of the handling opening and another twistlock accommodation part is transported to the location at which the next twistlock is to be expected, using the transport chain.

It is advantageous to dispose several transport chains having several accommodation parts on top of one another. In order to equip the transport chains that lie on top of one another, it is necessary that a vertical sled is disposed on the twistlock container, which moves the function head and the removed twistlock into the various levels to the transport chains, and passes it over to them. In the case of several transport chains that lie on top of one another, all of the twistlock accommodation parts that lie on top of one another are filled with twistlocks, at first, and afterwards, all the transport chains are moved further.

Because of the great loads that act on the twistlock container as a result of the container that is to be set down, it is advantageous to reinforce the container set-down locations on the twistlock container. Since the normal corner set-down points are no longer available, these project into the handling opening of the twistlock container with the twistlocks, the substitute set-down surfaces provided according to container regulations must be used. For this purpose, reinforcements in the form of set-down strips can be disposed on the twistlock container, which are provided with support profiles that act on the floor construction within a container.

Furthermore, it is advantageous to dispose a central set-down part in the center between the containers.

A regulation device for creating the distance between the containers is also advantageous.

Furthermore, an inspection opening in the container or in container parts is also advantageous.

Furthermore, it is advantageous to determine, by means of a sensor system, which container, e.g. 20 ft or 40 ft, is being set down onto the twistlock container, whether a twistlock is to be installed or removed, and if the twistlocks project into the handling openings.

The solution according to the invention has the advantage that twistlocks of containers of different sizes can be automatically and quickly removed from the corners of the containers, in any harbor, and new containers with which the ship is being loaded and which have a different size from the ones that were unloaded can be immediately and automatically provided with twistlocks, after which loading of the containers with the twistlocks inserted can take place. Afterwards, the twistlock containers can be loaded with the others, so that in the next harbor, after unloading and on the pier or on a platform on the container bridge of the twistlock containers, removal of the twistlocks from the unloaded containers can take place quickly and automatically. This not only makes quick loading and unloading of the containers possible, but also simple and inexpensive removal and installation of the twistlocks. The container is already detected by sensors as it approaches the twistlock containers, whereupon the twistlock grippers and the magazining devices are activated by means of suitable signals.

The automatic removal of twistlocks takes place in such a manner that the twistlock container is set down onto a predetermined location and fixed in place there, and adjusted in such a manner that the handling openings agrees with the position of the twistlocks at the container corners. Afterwards, the first container, with its twistlocks, is set down onto the twistlock container in such a manner that the predominant part of the twistlocks project into the handling openings of the container, after which these are gripped by the twistlock grippers in the container and removed from them. Setting the container down onto the twistlock container is performed by way of flipper centering devices, and registered by sensors. These can be disposed on or in the twistlock container. However, there is also the possibility that the sensors are disposed in the container and react to pressure or to twistlocks that project into the container. As soon as their end position has been reached, a signal is given to the twistlock grippers that grip the twistlock, turn, pull, and, if applicable, shake it, and pass it on to a transport unit. This transport unit can be a twistlock accommodation part on a transport chain, whereby several twistlock accommodation parts can be disposed on an endless chain, so that storing of the twistlocks in the twistlock accommodation parts of several chains is possible in such a manner that all of the twistlocks of one or more hatch cover lanes take place in twistlock accommodation parts of chains. Of course, there is also the possibility that the twistlock accommodation parts transport the twistlocks to a storage possibility and put them down there.

After all of the twistlocks have been removed from the containers of one or several hatch cover lanes, installation of the twistlocks takes place in the opposite manner. For this purpose, the first container is set onto the twistlock container, whereby the twistlocks of four corners of a container are inserted into the container at the same time, whereupon the latter is loaded onto the ship. This process of unloading and loading repeats itself multiple times, depending on how many container bridges are standing by the ship. The twistlock container is loaded onto the ship last.

As described, the twistlocks consisting of a series belong to the container ship. Therefore, on the entire cruise of the container ship, the same work is performed, again and again, to secure the load. Accordingly, the entire device for automatic handling of the twistlocks on containers could also be taken along with the ship.

In the following, the invention will be explained in greater detail using an exemplary embodiment and 20 figures. The figures show:

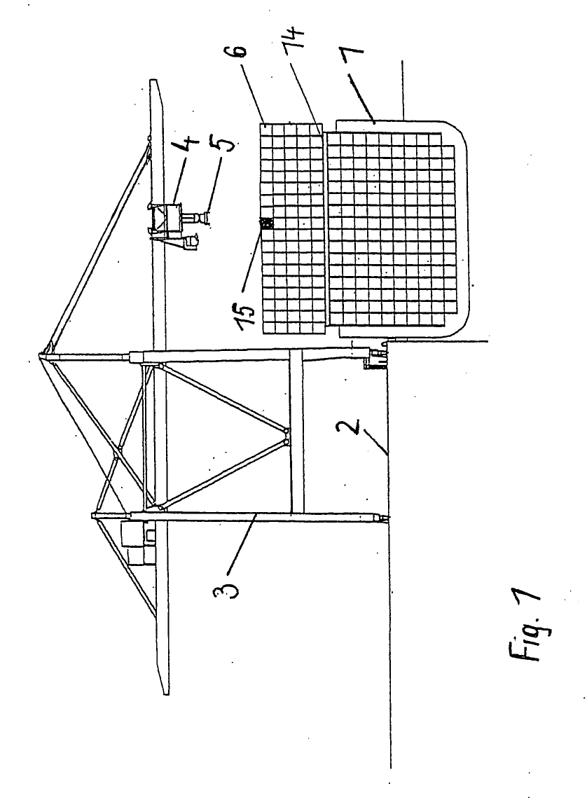

FIG. 1: Terminal with container crane, container ship, and twistlock container

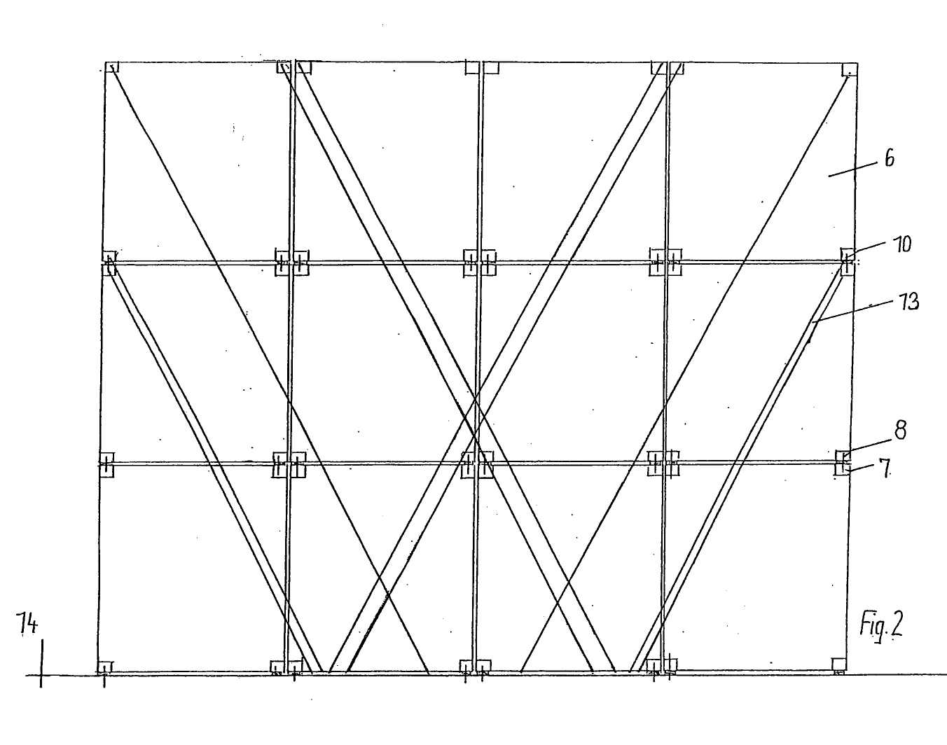

FIG. 2: Detail of container ship deck with container loading

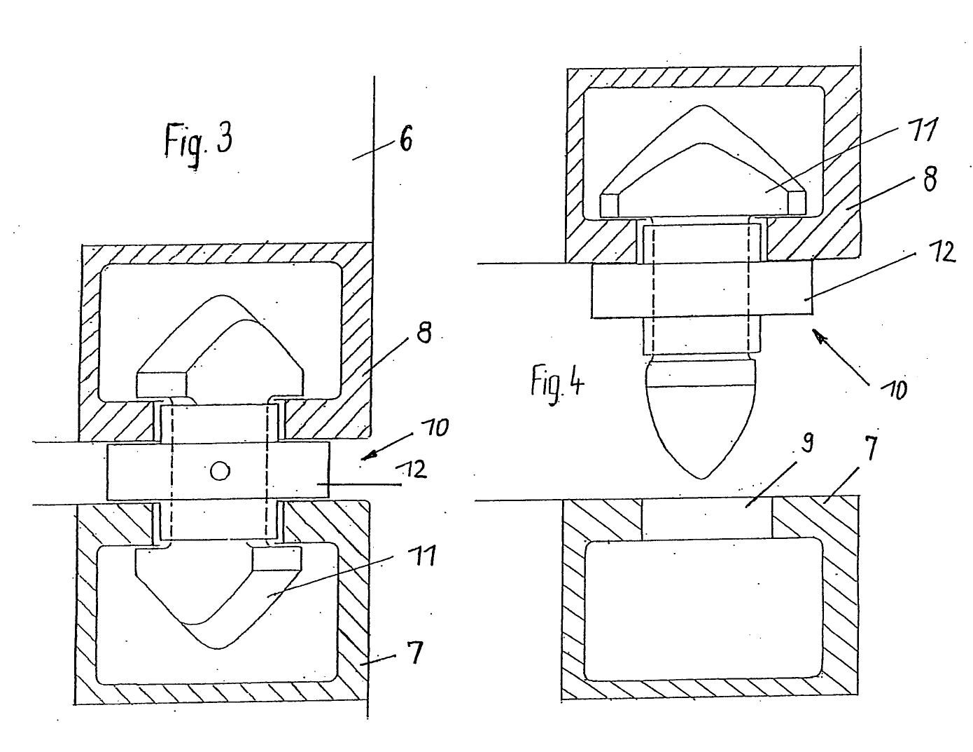

FIG. 3: Container corner fittings with locked twistlocks

FIG. 4: Container corner fittings with unlocked twistlocks

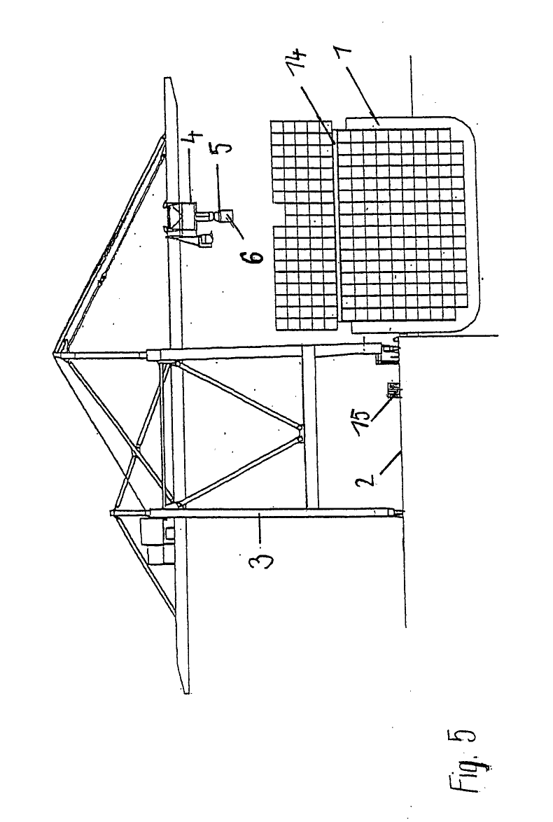

FIG. 5: Terminal with possible twistlock container locations

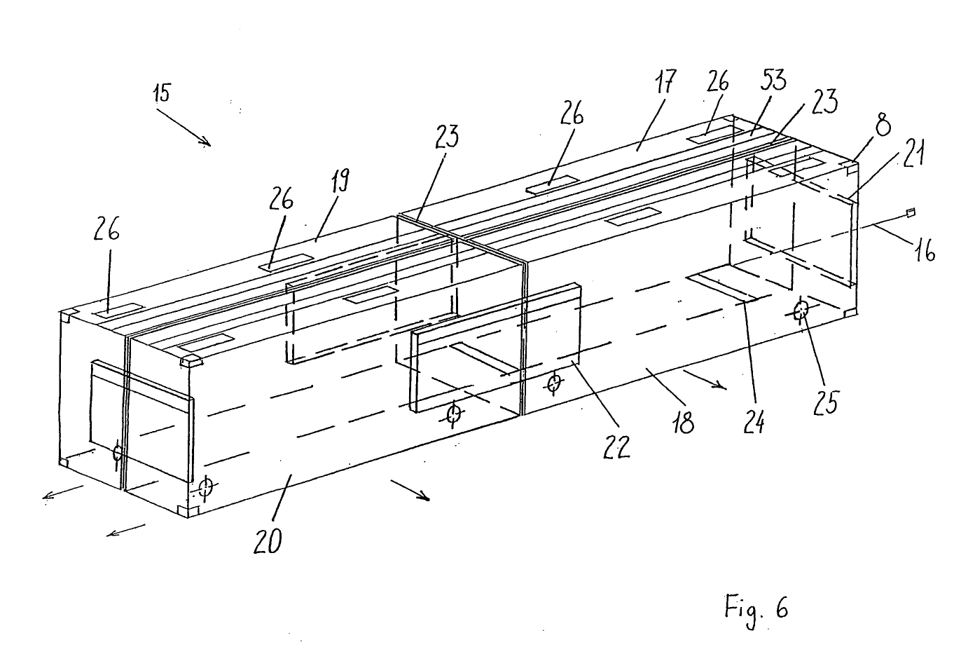

FIG. 6: Isometric representation of twistlock container, collapsed

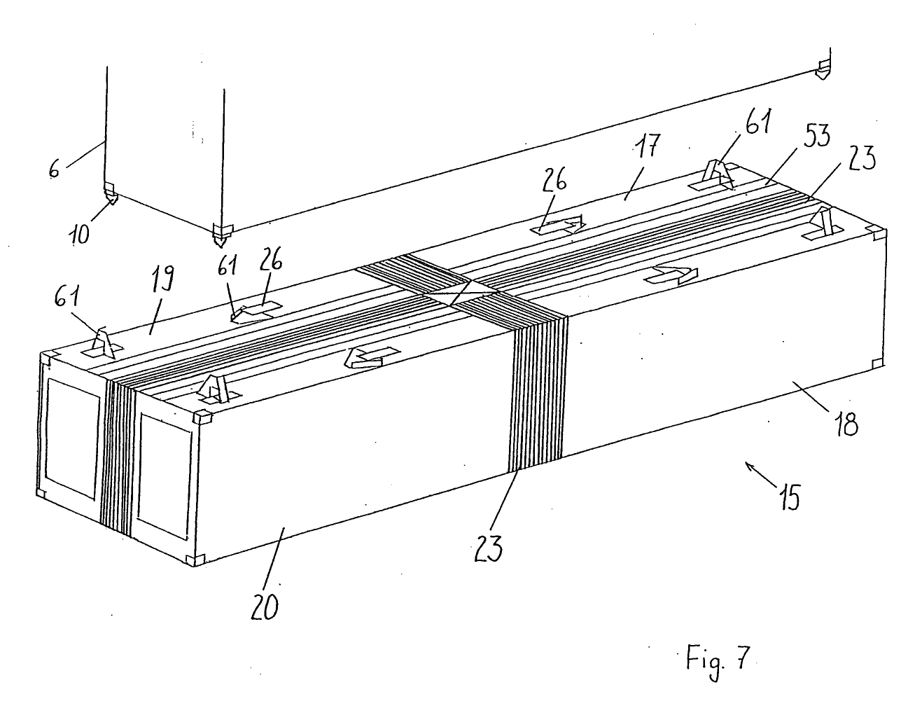

FIG. 7: Isometric representation of twistlock container, extended

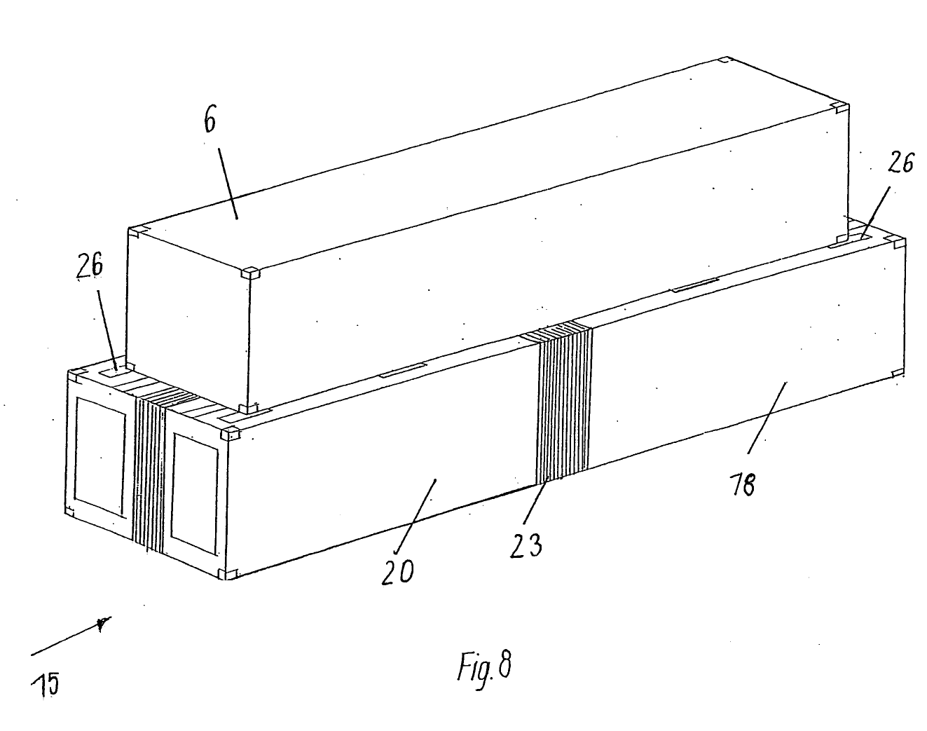

FIG. 8: Isometric representation of twistlock container, extended, with container

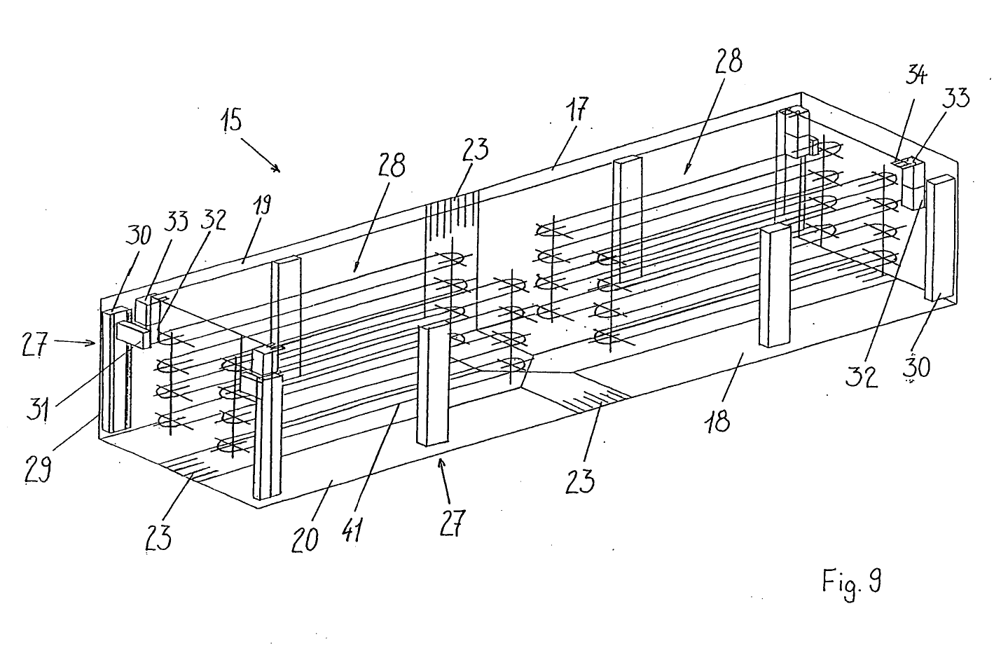

FIG. 9: Isometric representation of interior equipment

FIG. 10: Isometric detail representation of interior equipment

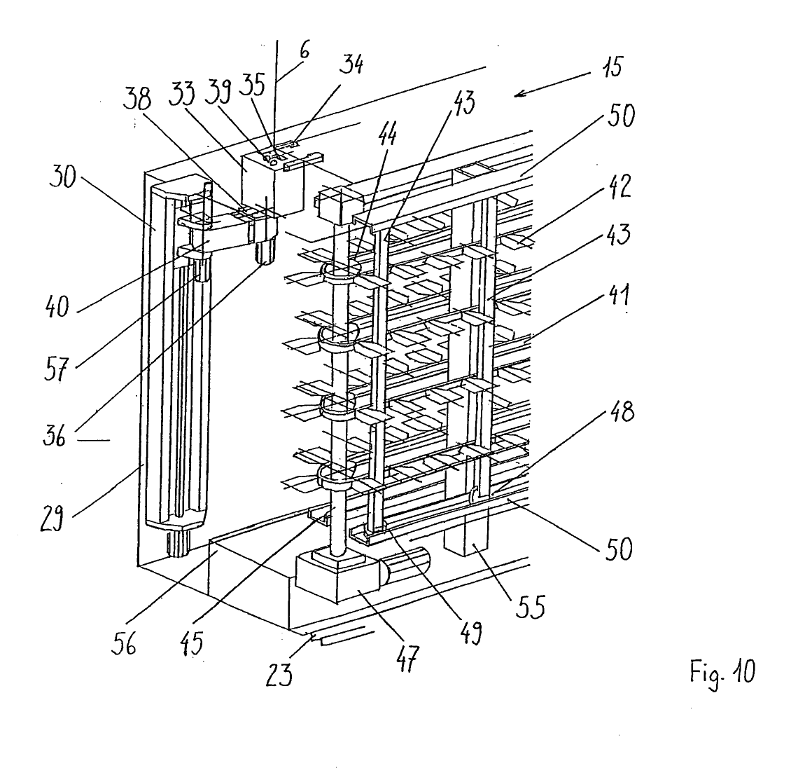

FIG. 11: Detail representation of twistlock handling and magazining device

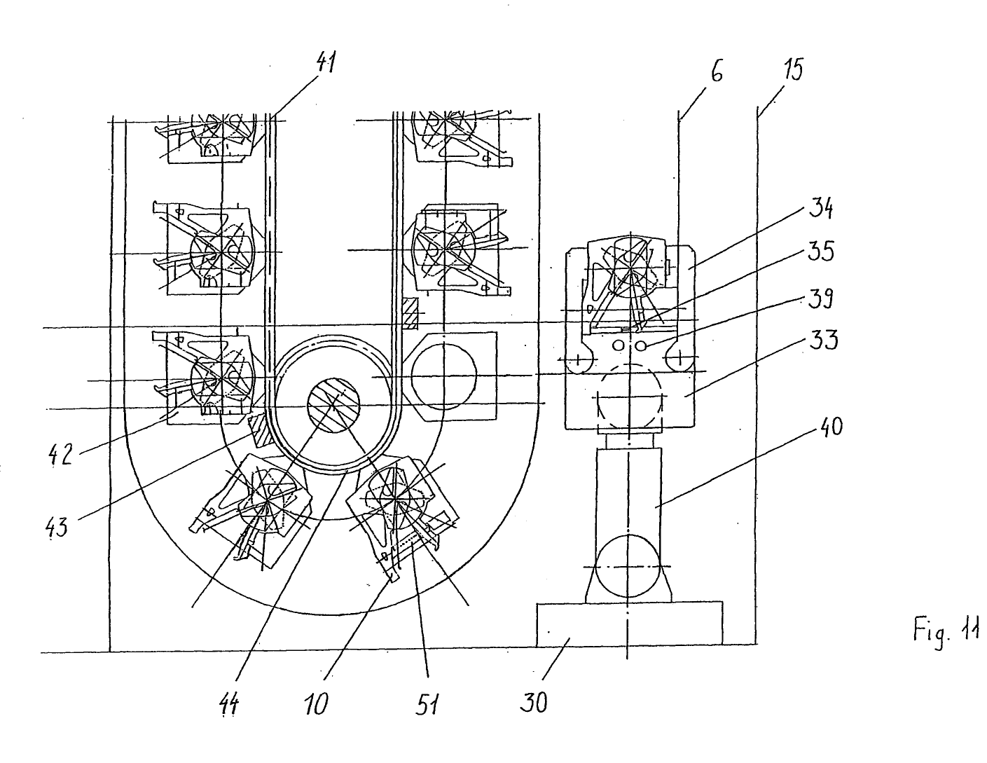

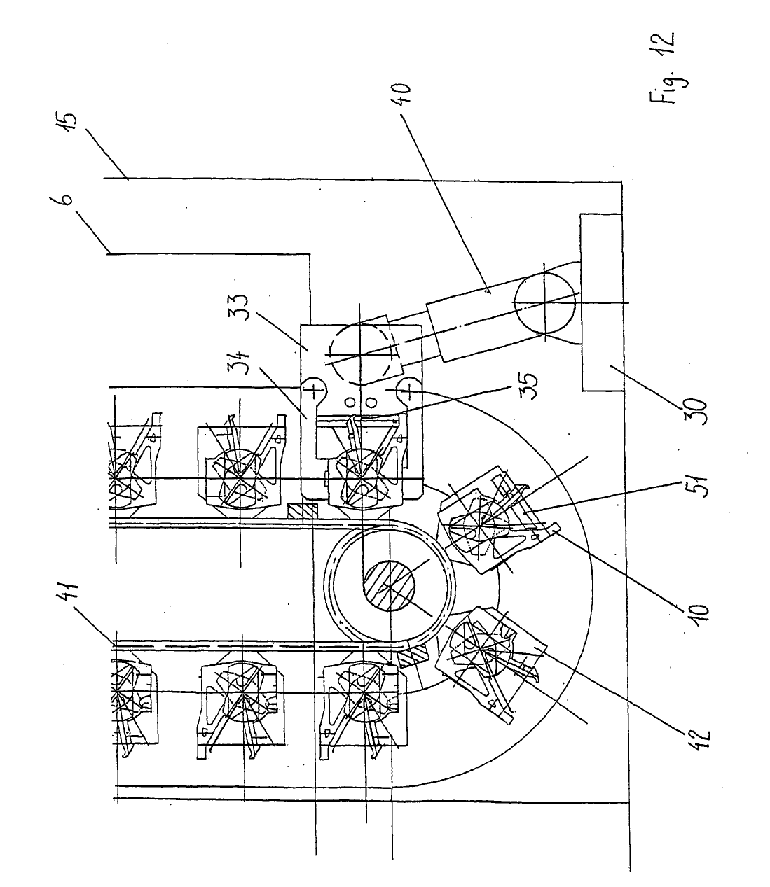

FIG. 12: Detail representation of twistlock placement in storage

FIG. 13: Cross-section of transport chains

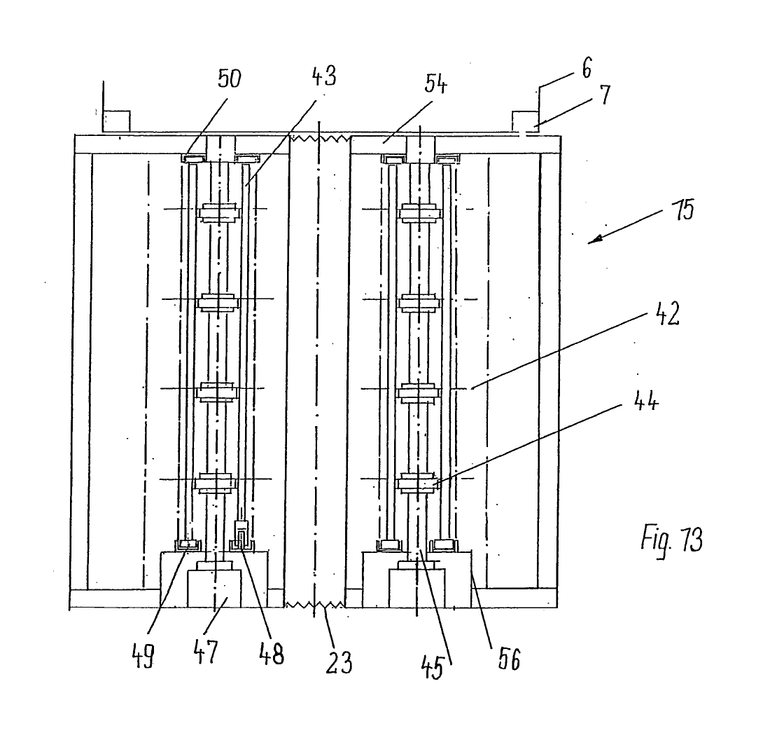

FIG. 14: Cross-section of twistlock handling device

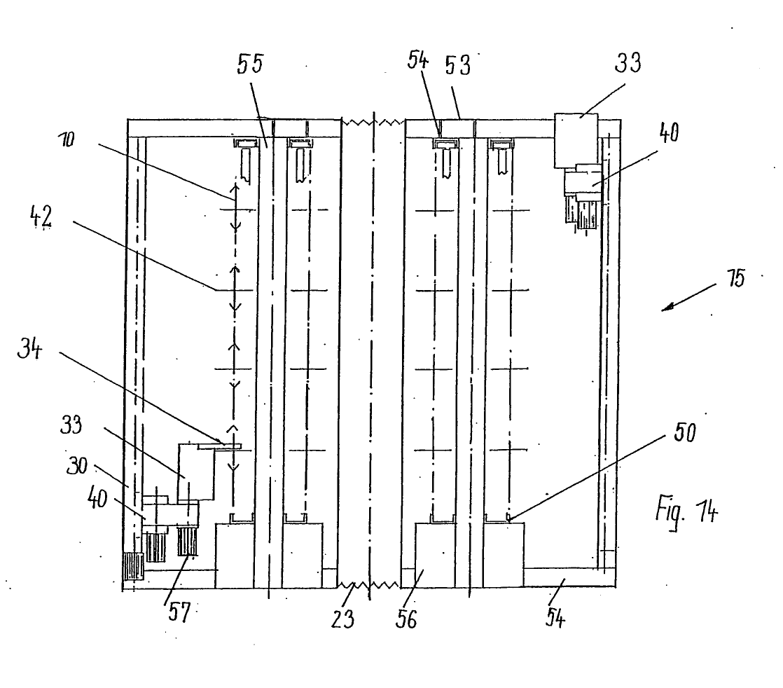

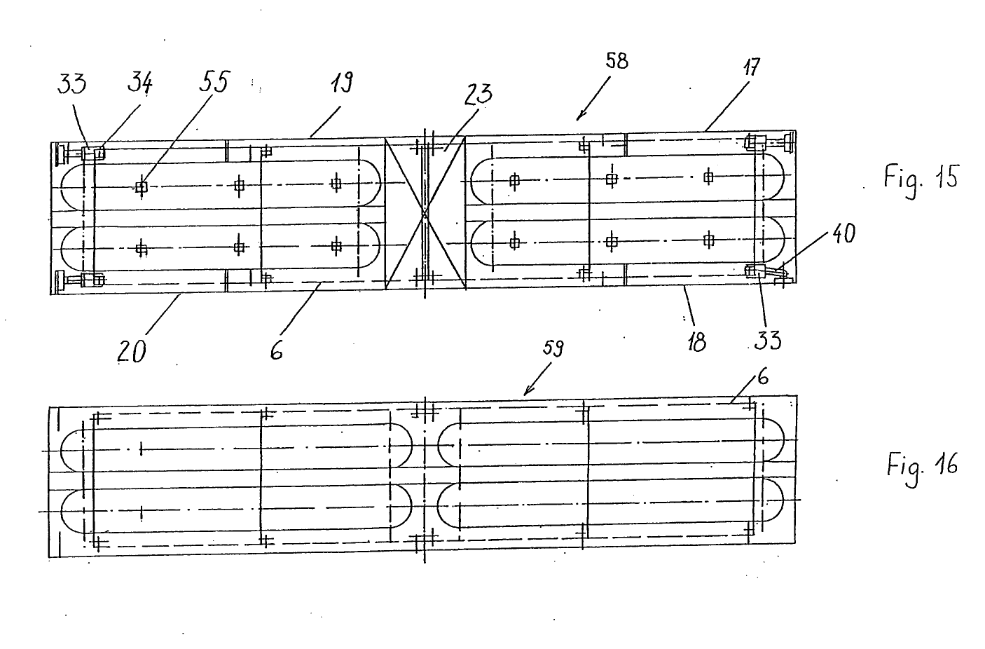

FIG. 15: Overview of 40 ft twistlock container

FIG. 16: Overview of 45 ft twistlock container

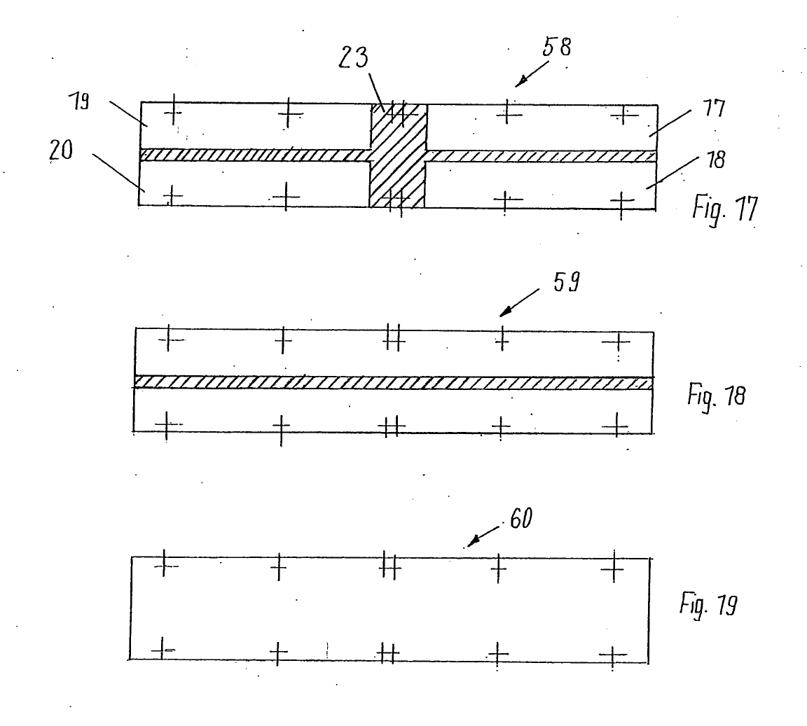

FIG. 17: Fundamental diagram of 40 ft twistlock container

FIG. 18: Fundamental diagram of 45 ft twistlock container

FIG. 19: Fundamental diagram of twistlock special container

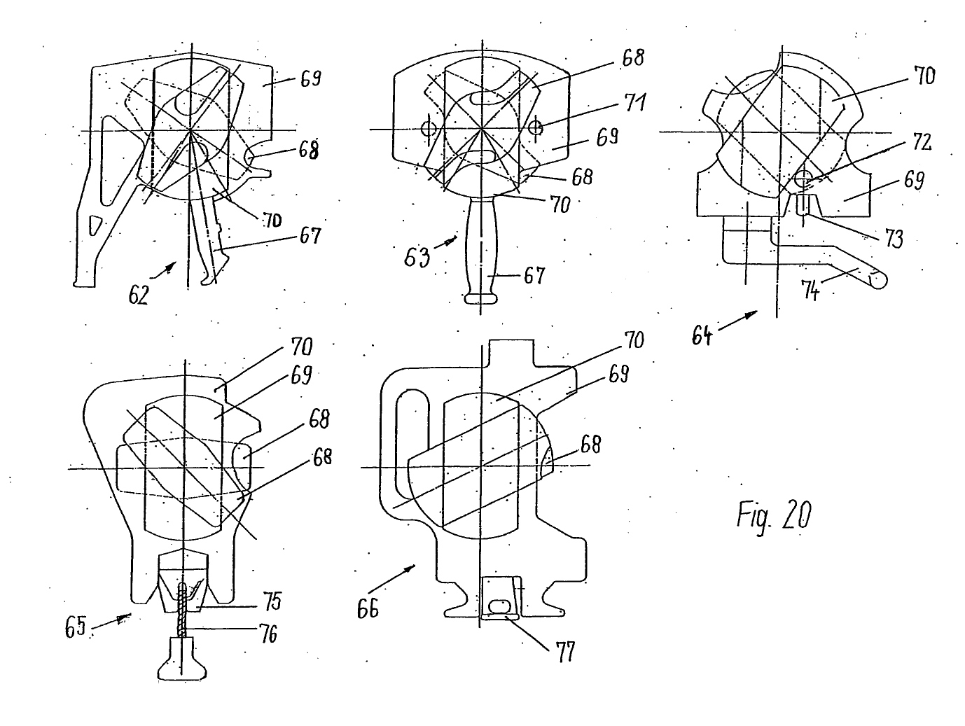

FIG. 20: Various twistlock variants that can be in and out

FIG. 1 shows the container ship 1 after it has docked at the pier 2. One or more container bridges 3 with the equipment container bridge trolley 4 and spreader 5 are set down by the container ship 1, for unloading and loading the containers 6. All containers 6 that are transported on deck 14 of the container ship 1 are secured to be seaworthy, by way of the container corner fittings 7, 8 with twistlocks 10 and tie rods 13 (FIG. 2).

The twistlocks 10 consist essentially of fit and spacer parts 11 that engage into the opening 9 of the corner fittings 7, 8, and of the hammer-like shaped parts 12 that are adjustable by hand or semi-automatically (FIG. 3).

After removal of the tie rods 13 and opening of the twistlocks 10, the containers with the twistlocks 10 projecting out of the lower container corner fittings 8 are ready for unloading (FIG. 4). Since the twistlocks 10 belong to the container ship 1 and one type of twistlocks 10 can be assigned per container ship, automatic removal is possible for the entire cruise of the container ship 1.

In accordance with the maximal possible number of container bridges 3 that are set onto the container ship 1, there are twistlock containers 15 on the container ship 1, with the complete device for automatic handling and magazining of the twistlocks 10 on different container sizes (FIG. 5).

After removal of the transport securing devices, the twistlock container 15 is brought to the pier 2 with the spreader 5 of the container bridge trolley 4, as the first unloading lift, and set up.

The twistlock container 15, which is dimensioned with the dimensions and the corner fittings of a 40 ft container 58, is connected with the container bridge 3 by way of an electrical cable 16.

Alternatively, a battery supply is possible, whereby the batteries can be charged on board, during the ship's travel. Furthermore, it is practical to control the complete procedure in the twistlock container 15 from the ship, by radio.

FIGS. 6 to 8 show the twistlock container in detail. The container 58 consists of four parts 17, 18, 19, 20 disposed next to one another, which are connected with one another by way of crosswise guides 21 and longitudinal guides 22, as well as deformable seals 23. The crosswise and longitudinal guides 21, 22 are structured to be resistant to bending. Proceeding from the fixed container part 17, which is equipped with set-down parts 24 and stands fixed on the floor/ground, the container parts 18, 20 are moved crosswise, and the container parts 19, 20 are moved longitudinally, by way of rollers or casters 25, until the handling openings 26 lie in the function region for removal of the twistlocks 10 on different container sizes. Set-down basins 53 that are reinforced are disposed at the openings 26 (see FIG. 14).

An alternative consists in moving all four container parts 17, 18, 19, 20 crosswise and longitudinally by way of a central support (not shown). For this purpose, casters are disposed under all the container parts 17, 18, 19, 20.

FIGS. 9, 10, 11, and 12 show the structure of the individual container parts 17, 18, 19, and 20. Each of the four container parts 17, 18, 19, 20 is equipped with a twistlock removal device, consisting of the main components handling device 27 and magazining device 28, all of which have the same construction.

The handling device 27 consists of the vertical adjustment unit 30 that is attached to the container wall 29, a vertically movable support arm 31, and a horizontal sled 32. The function head 33, which is designed as a function of the type of twistlock, is inserted in the horizontal sled 32. A twistlock gripper 34, several unlocking levers 35, a rotation device 36 for turning the function head 33, an elastic intermediate layer 37 disposed between the function head 33 and the horizontal sled 32, as well as a shaking device 38 for possibly loosening twistlocks 10 are built into the function head 33. Furthermore, sensors 39 for determining the actual status and for twistlock recognition are built in on the function head 33.

A variant of the support arm 31—horizontal sled 32 embodiment consists in the installation of a pivot arm 40, as shown in FIGS. 11 and 12.

FIGS. 13 and 14 show the twistlock removal and the magazining device. The magazining device 28 consists of one or more horizontally disposed transport chains 41 with attached twistlock accommodation parts 42, as well as transport chain connecting rods 43. The drive of the transport chain 41 takes place by way of chain wheels 44 that are set onto a drive shaft 45, under a deflection shaft 46. The drive motor 47 is directly attached to the drive shaft 45. For vertical force diversion, and for guidance, support rollers 48 and guide rollers 49 are attached to the connecting rods 43, which rollers in turn are guided in U-shaped profiles 50.

To secure and hold their position in the accommodation parts 42, the twistlocks 10 are held in place by means of fixation elements 51 and removal locks 52 during transport on sea and on land.

By dividing a 40 ft container into four parts 17, 18, 19, 20, set-down surfaces have to be created for setting down containers 6, and a container reinforcement must be carried out. The reinforcement consists of the container set-down plates 53, the reinforcement plates 54, the support profiles 55, and a base construction 56 (FIG. 14).

FIGS. 15 to 19 show arrangements of the container parts 17, 18, 19, 20 for different container sizes from 40 ft to 60 ft. In this connection (FIG. 16, 18), it is alternatively possible to structure the twistlock container 15 only with a crosswise adjustment, when using a 45 ft container 59.

Furthermore, it is possible (FIG. 19) that the twistlock container is structured without a crosswise and longitudinal adjustment. This container 60 would be a special container and would have to be handled accordingly.

FIG. 20 shows different types of twistlocks that can be installed and removed using the device according to the invention.

In the following, the method for automatic removal of the twistlocks will be described.

After the twistlock container 15 has been checked for operational readiness, the removal sequence begins. Since the twistlock container 15 does not know what container size, 20 ft or 40 ft, is going to be delivered next, all of the function heads 33 with the built-in sensors 39 go into waiting position. In this connection, the sensors 39 responsible for the container size look vertically upwards. If a container 6 at 40 ft, for example, approaches, the sensors 39 responsible for this are addressed. Immediately, messages go to the 40 ft flippers 61 on the top of the twistlock container 15, for immediate extension, to the function head twistlock grippers 34, to open the grippers, to the magazining device 27 to make a free storage location available, and to the 20 ft function heads 33 to return to the parked position. During the further lowering procedure, the incoming container 6 is centered by way of the flippers 61, and set onto the twistlock container 15. In this connection, the projecting twistlocks 10 move into the opened grippers 34 of the function head 33 that is standing ready. After the twistlock 10 has been gripped n the center region of the fit and spacer part 12, movements for loosening the twistlocks 10 are performed with the function head unlocking levers 35. A shaking device 38 built into the function head 33 can support the loosening process.

The loosened twistlock 10 is moved out at the opening 9 of the corner fittings 8, using the gripper 34.

After removal of all the twistlocks 10, the container 6 is ready for further transport.

To magazine the twistlocks 10, there are 160 accommodation parts 42 for each container corner in the twistlock container 15, on four levels. The twistlock 10 removed from the container 6 is brought to the predetermined storage location of the magazining device 27 the twistlock handling device 27, by means of lowering and rotational movements, and an accommodation part 42 is set down in fixation elements 51, so that it cannot rotate.

For installation of twistlocks 10 into containers 6, the reverse procedure applies.

The number of 160 twistlock storage locations per container corner is sufficient, since a maximum of 120 containers 6 are located on the deck of a large container ship 1, in one hatch cover lane, and during the container loading and unloading procedure, unloading and loading take place before the container bridge 3 is moved.

In the following, the installation and removal of the twistlocks shown as examples will be described, as it can be seen in FIG. 20. FIG. 20 shows five different twistlocks that can be handled by different function heads 33 in the twistlock container 15. The function heads 33 are interchangeable, in accordance with the twistlocks 62, 63, 64, 65, or 66 to be handled.

The twistlock 62 is shown in the locked position in FIG. 20, i.e. in this position, two containers 6 are connected with one another by means of the twistlock 62. The containers 6 are released from one another in that the manual rotation lever 67 is pivoted 40° to the left, against the stop, and held in this position by means of a spring pin. When the upper container 6 is lifted off, the twistlock 62 remains in its container corner 7.

Loosening of the twistlock 62 currently takes place manually, by means of turning the hand lever 67 by 40° to the right, back to the zero position, pulling it out approximately 5 mm, and pivoting it further by 20° to the right.

Introduction of the twistlock 62 takes place in the 20° position of the lever 62. So that the twistlock 62 remains in the container corner 7, the lever is pivoted back to the zero position. This is also the starting position for the automatic locking of two containers 6 on the deck.

The twistlock 63 in FIG. 20 is shown in the locked position, i.e. in this position, two containers 6 are connected with one another by means of the twistlock 63. The containers 6 are released from one another in that the manual rotation lever 67 is pivoted 30° to the left and held in this position by means of a spring pin. This lever movement is only possible if the pressure pins 71 in the housing are pressed down by the container weight. When the upper container 6 is lifted off, the twistlock 63 remains in its container corner 7.

Loosening of the twistlock 63 takes place by means of turning the hand lever 67 beyond the zero position, to the right stop, i.e. by a total rotation of 60°. This is only possible when the pins 71 are pressed in.

Introduction of the twistlock 63 into the container corner 7 takes place in the 30° stop position of the hand lever 67. So that the twistlock 63 remains in the container corner 7, the lever is pivoted back to the zero position. This is only possible when the pins 71 are pressed in. The twistlock 63 is therefore in the starting position for automatic locking.

The twistlock 64 in FIG. 20 is shown in the locked position, i.e. in this position, two containers 6 are connected with one another by means of the twistlock 64. The containers 6 are released from one another in that the hand lever 74 is pivoted 45° upwards. When the upper container 6 is lifted off, the twistlock 64 remains in its container corner 7.

Loosening of the twistlock 64 takes place by means of turning the entire housing 69 by 35°, whereby the unlocking lever 73 must be moved downward by 15 mm. This causes the locking pin 72 to be moved into the housing 69, and thereby permits the described rotation of the housing 69 with the fixed twistlock part 70. In this connection, the hand lever 74 must be in its starting position.

Introduction of the twistlock 64 takes place analogous to releasing it from the container corner 7. The twistlock housing 69 is attached in the container corner 7 with a 35° rotation, whereby the locking pin 72 with the lever 73 must be pulled into the housing 69. After the positioning is complete, the locking pin 72 secures the twistlock 62 to prevent unintentional loosening. The hand lever 74 must be brought into the starting position for the subsequent automatic locking.

In FIG. 20, the twistlock 65 is shown in the locked position, i.e. in this position, two containers 6 are connected with one another by means of the twistlock 65. The containers 6 are released from one another in that the tackle line 76 is fully pulled out, and locked in place in the outer slit of the spacer plate 75. When the upper container 6 is lifted off, the twistlock 65 remains in its container corner 7.

Loosening of the twistlock 65 takes place by means of pulling the tackle line 76 out to half its length, and corresponding locking in a lateral slit of the spacer plate 75.

For introduction of the twistlock 65, the tackle line 76 is biased as described, i.e. locking of the line 76 is located in the lateral slit of the spacer plate 75. So that the twistlock 65 remains in the container corner 7, the tackle line 76 is released from this lock, so that the line 76 is retracted into the housing 69 by means of spring force. This is the starting position for automatic locking of two containers 6 on the deck.

The twistlock 66 is shown in the locked position in FIG. 20, i.e. in this position, two containers 6 are connected with one another by means of the twistlock 66. The containers 6 are released from one another in that the tie rod 77 is pulled out of the housing 69 by 25 mm. When the upper container 6 is lifted off, the twistlock 66 remains in its container corner 7.

Loosening of the twistlock 66 from the container corner 7 takes place by means of turning the lower twistlock bolt 68 by 150°.

Introduction of the twistlock 66 takes place with the tie rod 77 moved into the housing 69. So that the twistlock 66 remains in the container corner 7, the lower twistlock bolt is turned by 65°, against spring pressure. After the upper twistlock bolt has been introduced into the container corner 7, the latter turns back to the starting position due to spring pressure, and is therefore ready for automatic locking of two containers 6.

### REFERENCE SYMBOLS USED

1 container ship
2 pier
3 container bridge
4 container bridge trolley
5 spreader
6 container
7 upper container corner fitting
8 lower container corner fitting
9 opening in the corner fitting
10 twistlock
11 hammer-like shaped part
12 fit and spacer part
13 tie rods
14 deck, container ship
15 twistlock container
16 electrical cable
17 container part, fixed
18 container part, crosswise travel
19 container part, longitudinal travel
20 container part, crosswise/longitudinal travel
21 crosswise guide
22 longitudinal guide
23 seal
24 set-down part
25 casters
26 handling opening
27 handling device
28 magazining device
29 container wall
30 vertical unit
31 support arm
32 horizontal sled
33 function head
34 twistlock gripper
35 unlocking lever
36 rotation device
37 elastic intermediate layer
38 shaking device
39 sensors
40 pivot arm
41 transport chains
42 twistlock accommodation part
43 connecting rod
44 chain wheels
45 drive shaft
46 deflection shaft
47 drive motor
48 support rollers
49 guide rollers
50 U-shaped profile
51 fixation element
52 removal lock
53 container set-down plate
54 reinforcement plate
55 support profile
56 base construction
57 setting motor
58 container 40 ft
59 container 45 ft
60 special container
61 flipper/centering element
62 twistlock shape A
63 twistlock shape B
64 twistlock shape C
65 twistlock shape D
66 twistlock shape E
67 rotation lever
68 twistlock with insertion phases
69 housing
70 centering fixed on the housing
71 pressure pin
72 locking pin
73 lever
74 hand lever
75 spacer plate
76 tackle line/line
77 tie rod

1. Device for automatically installing or removing twistlocks (10) in the corners (7, 8) of containers, to connect containers (6) with one another, in order to increase stability during transport, consisting of a twistlock container (15) having a container set-down plate (53) on the surface of the container (15), handling openings (26), into which the predominant part of the twistlocks (10) project after the container (6) has been set down, handling devices (27) for removing or installing the twistlocks (10) from or into the containers (6), and a sensor system with which the container (6) is detected, and which triggers a signal, whereupon the twistlock grippers (34) and the magazining device (28) in the container (15) are activated.

2. Device according to claim 1, wherein the container (15) consists of container parts (17, 18, 19, 20), the distance of which, relative to one another, is adjustable.

3. Device according to claim 1, wherein a sensor system (61) built into and/or onto the twistlock container (15) is present, to detect the container size, the twistlocks (10), and the container set-down procedure.

4. Device according to claim 1, wherein a set-down part (24) is disposed on a container part (17, 18, 19, 20), with which the container part (17, 18, 19, 20) can be fixed in place relative to its substratum (2).

5. Device according to claim 1, wherein the container parts (17, 18, 19, 20) are provided with longitudinal rollers, crosswise rollers, or casters (25) on their underside.

6. Device according to claim 1, wherein seals (23), crosswise and longitudinal guides (21, 22) are disposed between the container parts (17, 18, 19, 20).

7. Device according to claim 1, wherein a shaking device (38) is disposed on the function head (33).

8. Device according to claim 1, wherein twistlock accommodation parts (42) are disposed on a transport chain (41), in the container parts (17, 18, 19, 20), in which the twistlocks (10) are set down from the twistlock gripper (34).

9. Device according to claim 1, wherein several transport chains (41) with accommodation parts (42) are disposed on top of one another, and vertical unit (30), consisting of support arm (31) and horizontal sled (32), assure transport of the twistlocks (10) to the various transport chains (41).
